(19) United States
(12) Patent Application Publication
(10) Pub. No.: US 2007/0136821 A1
(43) Pub. Date: Jun. 14, 2007

(54) METHOD AND SYSTEM FOR PROTECTING USER DATA IN A NODE

(75) Inventors: Richard Dan Hershaft, Whitestone, NY (US); Alan Gerald Carlton, Mineola, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/609,039

(22) Filed: Dec. 11, 2006

Related U.S. Application Data
(60) Provisional application No. 60/750,030, filed on Dec. 13, 2005.

(51) Int. Cl. H04L 9/32

(52) U.S. Cl. 726/27

(57) ABSTRACT

A method and system for protecting data stored in a node are disclosed. Upon detection of an attempt to compromise security at a residing node, the data may be moved from the residing node to an escrow node which is a trustworthy intermediary node. The data may be encrypted prior to transmission to the escrow node. Stakeholders of the data may be notified of such movement so that the stakeholders may take action. An attempted breach of security may automatically place the residing node in a compromised state, upon which the owner may submit the residing node to a security bureau to clear the compromised state. The escrow node may transfer the data to an off-site node if the owner or user of the residing node is not trustworthy. The residing node may send a message to an intermediary node as a notification regarding a breach in security, and encrypts the data with a new encryption key issued by the intermediary node.

### CROSS REFERENCE TO RELATED APPLICATION

This application claims the benefit of U.S. Provisional Application No. 60/750,030 filed Dec. 13, 2005, which is incorporated by reference as if fully set forth.

### FIELD OF INVENTION

The present invention is related to data security. More particularly, the present invention is related to a method and system for protecting data stored in a node.

### BACKGROUND

Computer security software is ubiquitous in today's digital world. One of the security software products available to users is known as The CyberAngel®. The CyberAngel® detects unauthorized access to, or possible theft, of a computer and alerts a user within several minutes. The CyberAngel® may also lock the communication ports, the mouse, and the keyboard, and prevent data transmission upon detection of the unauthorized access or possible theft. This prohibits an intruder from accessing, copying, downloading or printing of any files. The CyberAngel® requires that a valid user supply an unprompted password. Any use without the input of the unprompted password is considered as an attempted security breach.

Another security software product is known as ComputracePlus, by which data on a stolen computer can be deleted. To protect data on a computer, ComputracePlus customers have the option of subscribing to a data delete service which deletes valuable data from the computer if it is stolen. This data delete service prevents a thief from accessing and compromising the data. The data delete service works in the background to erase data from the computer, and can be configured to include or exclude the computer's operating system.

The state of security existing at a node may change over time. A node that was deemed to be highly secure at one time may become insecure. A node, onto which user data was placed when the node was secure, needs to monitor its level of security continuously, (or periodically), and take actions to protect the data that is residing on it if the node's level of security decreases. Conventional systems do not address this issue other than just sending audit messages when certain operations are performed on user data.

### SUMMARY

The present invention is related to a method and system for protecting data stored in a node. Upon detection of an attempt to compromise security at a residing node, the data may be moved from the residing node to an escrow node which is a trustworthy intermediary node. The data may be encrypted prior to transmission to the escrow node. Stakeholders of the data may be notified of such movement so that the stakeholders may take action. An attempted breach of security may automatically place the residing node in a compromised state, upon which the owner may submit the residing node to a security bureau to clear the compromised state. The escrow node may transfer the data to an off-site node if the owner or user of the residing node is not trustworthy. Alternatively, a usage right associated with the data may be disallowed. In an alternative embodiment, a message may be sent to a generator of the data to inform the generator of the attempted or successful breach in security, whereby the generator takes an action to protect the data. In yet another alternative, the residing node may send a message to an intermediary node as a notification regarding the breach in security, and encrypts the data with a new encryption key issued by the intermediary node.

### BRIEF DESCRIPTION OF THE DRAWINGS

FIG. 1 is a block diagram of a node configured in accordance with the present invention.

FIG. 2 is a block diagram of a system for protecting data in accordance with one embodiment of the present invention.

FIG. 3 is a block diagram of a system for protecting data in accordance with another embodiment of the present invention.

FIG. 4 is a block diagram of a system for protecting data in accordance with yet another embodiment of the present invention.

### DETAILED DESCRIPTION OF THE PREFERRED EMBODIMENTS

The features of the present invention may be incorporated into an integrated circuit (IC) or be configured in a circuit comprising a multitude of interconnecting components.

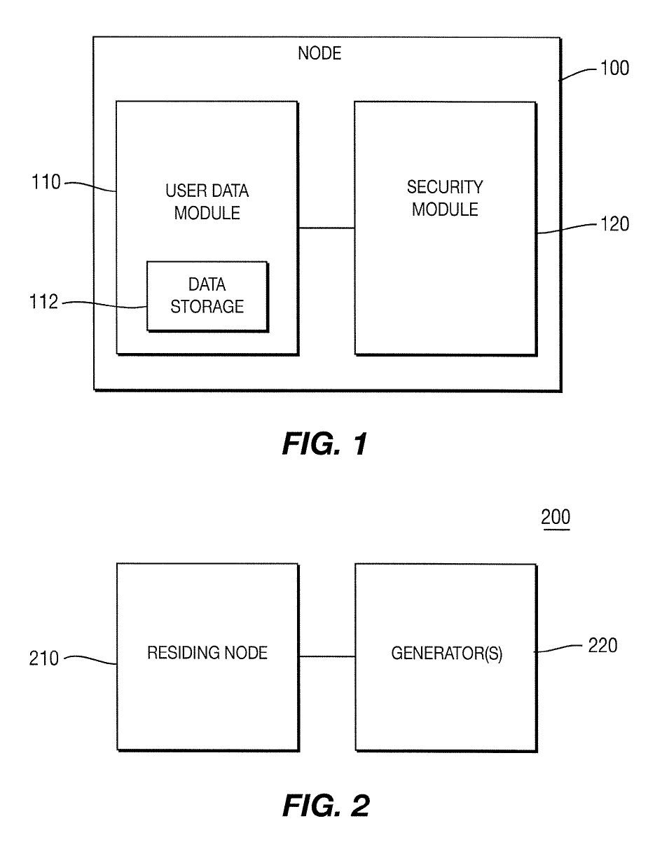

FIG. 1 is a block diagram of a node 100 configured in accordance with the present invention. The node 100 includes a user data module 110 and a security module 120. The user data module 110 includes data storage 112 for storing data. The security module 120 generates and gathers behavior metrics, and performs an evaluation of the security level of the node 100 based on a security policy, periodically or continuously, so that protective actions may be immediately taken when needed.

The behavior metrics may indicate that malware has been detected, that anti-virus software is out-of-date, that digital signatures or hash codes of software, firmware, and configuration data cannot be verified, that an attempt to penetrate the physical security of the node has been detected, that the node has accessed or was accessed by other nodes having a certain probability of being compromised, and that the node is taken out of or placed into certain physical locations.

An evaluation procedure involves any logical formula where the behavior metrics are used as inputs. For example, the evaluation procedure may be a set of ordered rules where, for each rule, if a combination of conditions are present, a set of actions are taken. The evaluation procedure may also take the form of a weighted sum with a threshold or a set of thresholds, each associated with a different security level or may comprise more elaborate if-then statements. When the security module 120 detects an attempt to compromise security of the node 100, the node 100 implements a security mechanism in accordance with the present invention, which will be explained in detail hereinafter.

The data is associated with usage rights and a security policy. The usage rights involve rights to render, edit, alter or distribute the data. The security policy guides the evaluation of the security level of the node 100 and specific security aspects at the node 100. The security level is related to the usage rights as specific rights may be based on a particular aspect of security existing at the node 100. Determining the security level of a node may be used to restrict usage rights, such as preventing the ability to print, copy, or distribute the associated data. Shutting down these rights makes the data largely inaccessible. However, with a node under attack, there may be a way to extract a decryption key or to circumvent the programming code that follows the access instructions inherent in the associated usage rights. The present invention makes the data impervious to an attack on the system through the use of entombment and escrowing.

Digital rights management (DRM) is used to associate the data with the usage rights. The usage rights are specified with a rights expression language (REL). The REL is a language for specifying rights to content, fees or other consideration required to secure those rights, types of users qualified to obtain those rights, and other associated information necessary to enable transactions in content rights. The REL offers an approach for associating inputs concerning a security breach with outputs for controlling the protection of data that is more flexible than a hard-coded algorithmic approach. The exemplary association of the security breach with the protective actions is shown in Table 1.

TABLE 1

| | Security Policy | |
|---|---|---|
| | Type of Breach | |
| Data Entity/Object | (Behavior Metric) | Protective Action |
| Downloaded Video | Virus detected | Escrow data - allow for |
| | | data to be placed on an |
| | | alternate residing node. |
| Vital medical data | Physical | Escrow data - allow for |
| needed for life | penetration | data to be placed on an |
| support | detected | off-site node. |
| | Virus detected | Escrow data - allow for |
| | | data to be placed on an |
| | | alternate residing node. |
| Vital medical data | Physical | Escrow data - allow for |
| needed for life | penetration | data to be placed on an |
| support | detected | off-site node. |
| Jointly developed | Virus detected | Escrow data - return each |
| software | and digital | software addition/ |
| | signature | modification back to its |
| | verification | contributor. |
| | failed | |
| Personal | Virus software | Entomb data - decryption |
| correspondence | is out-of-date | key is encrypted and placed |
| belonging to user | | on a server accessible to |
| of node | | the node's user. |

DRM can be extended so that control mechanisms may be initiated based on the data owner's preferences as specified by the security policy using an extension to the REL. In addition to security policies being specified by data owners, the owner or user of the node 100 may specify the security policy for how the node 100 should handle security related aspects. For example, the security extensions to the REL may be used to protect the data by specifying an allowed transfer of the data to other nodes. The security policy may be desired for expediency and as a safety net for data on the node 100 that is owned by the owner or user of the node 100, and may be based on a moral or legal obligation that the owner or user of the node 100 has for the protection of the data of others that resides on the node 100. The security policy may be expressed using extensions to the REL. The security policy is communicated as highly flexible content in a field in a protocol, such as open mobile alliance (OMA) or rights object acquisition protocol (ROAP).

In addition to extending the REL with the security policy, a common but less flexible security policy may be hard-coded in the protocol by adding messages or fields in existing messages. Placing security related data directly in the protocol may allow for a more efficient flow of messages.

The security policy states that under what circumstances, which data should be “escrowed” or “entombed”, where the data should be sent with or without encryption, whether and when to destruct the data, or the like, which will be explained in detail hereinafter. The allowed usage of the data as expressed in the security policy may be contingent on the node possessing a certain security state.

When a state of compromised security at the node is detected, a protection mechanism, (passive or active), is implemented. In accordance with the present invention, upon detection of an attempt to compromise security, and before the attack is successful, a usage right may be disallowed as a passive protection mechanism. An active protection mechanism is explained hereinafter.

FIG. 2 is a block diagram of a system 200 for protecting data in accordance with one embodiment of the present invention. The system 200 includes a residing node 210 and at least one generator 220. The data is currently stored in the residing node 210. Behavior metrics of the residing node 210 are continuously, or periodically, generated and evaluated in accordance with the evaluation policies for the data. Upon detection of an attempt to compromise security in the residing node 210, a message is sent to the generator(s) 220 of the data, (i.e., the owner of the data), so that the generator(s) 220 may take action to protect the data. The message may include either a general warning or specific information about the attempt. The data may be identified with a universal unique identifier (UUID) assigned to the data when the data is generated.

There may have been many parties involved along the way as the data was being formed into its current state. A change history for the data may be maintained, and the paths that were followed to generate the data are retraced to send the data to the generators(s) 220. The security policy associated with the data may indicate that the data only needs to be partially retraced.

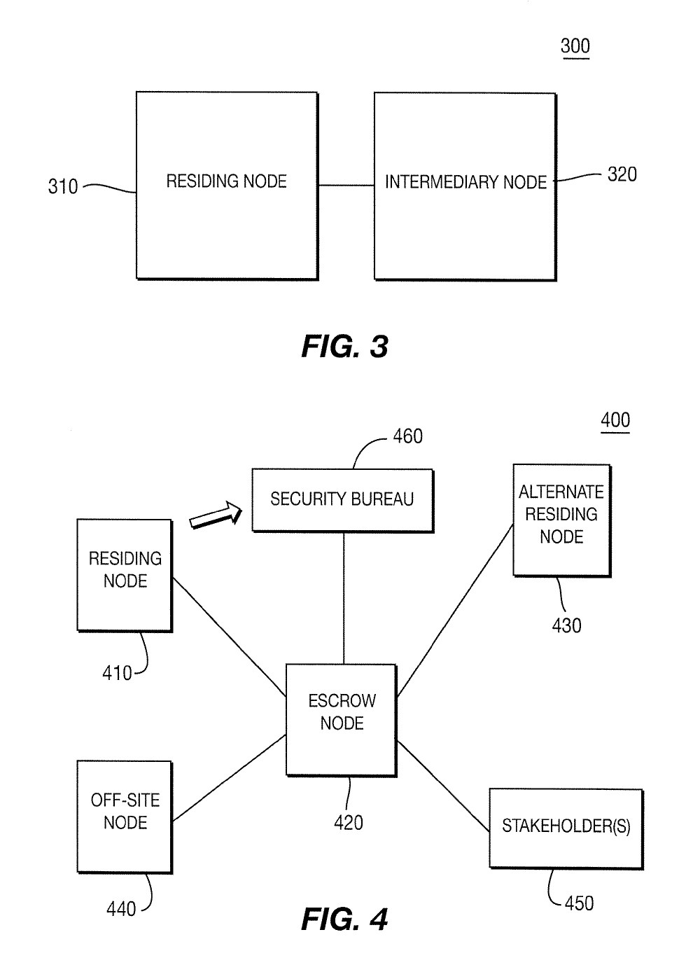

FIG. 3 is a block diagram of a system 300 for protecting data in accordance with another embodiment of the present invention. The system 300 includes a residing node 310 and an intermediary node 320. The data is currently stored in the residing node 310. Behavior metrics of the residing node 310 are continuously, or periodically, generated and evaluated in accordance with the security policy for the data. Upon detection of an attempt to compromise security in the residing node 310, the intermediary node 320 is informed about the attempt by the residing node assuming a communication channel is functioning. The intermediary node 320 issues an encryption key, (e.g., a public key), to the residing node 310. The residing node 310 encrypts all or a portion of the data using the encryption key. After encrypting the data, an unencrypted version of the data is deleted. Since a decryption key, (e.g., a private key), is only known to the intermediary node 320, the residing node 310 or other nodes are no longer on their own able to access the data, (i.e., the data is in an “entombed state”).

Since encrypting a large amount of data with a public key can be a time consuming procedure, the intermediary node 320 may supply the public key in advance so that encryption may be performed in the background on a continuous basis. Entombment in this case means deleting the plaintext data. Since symmetric encryption is much faster than asymmetric encryption, the intermediary node 320 may periodically issue a symmetric key to be used for the background encryption of data. Each time a new symmetric key is issued by the intermediary node 320, the residing node 310 encrypts the old symmetric key with a public key issued by the intermediary node 320 and deletes the old symmetric key. The encrypted symmetric keys remain associated with their corresponding sections of data. When the need for entombment arises, most of the data is already entombed and the residing node 310 only needs to encrypt any remaining plaintext with the last received symmetric key and then deletes the symmetric key.

The symmetric key may be encrypted by the intermediary node's public key when the symmetric key is first received. In fact, when the symmetric key is received by the residing node 310, it can be accompanied by the symmetric key already encrypted with the intermediary node's public key or even with a symmetric key that is only known by the intermediary node 320. Alternatively, each symmetric key sent by the intermediary node 320 may be accompanied by a code which the intermediary node 320 may use to look up the symmetric key. The residing node 310 has this code be associated with data that the corresponding symmetric key encrypts. Having a copy of data stored on a hard drive in encrypted form that may never be used unless the node experiences an attempted security breach may be considered costly. This same data may be considered a backup in case the working copy of data is accidentally erased. If this pre-entombed data is kept on a separate physical disk drive then this extra copy of the data may serve as protection for a disk drive failure.

FIG. 4 is a block diagram of a system 400 for protecting data in accordance with yet another embodiment of the present invention. The system 400 includes a residing node 410, an escrow node 420, an alternate residing node 430 (optional), an off-site node 440 (optional), stakeholders of the data 450, and a security bureau 460 (optional). The data is currently stored in the residing node 410. Behavior metrics of the residing node 410 are continuously, or periodically, generated and evaluated in accordance with the security policy for the data. Upon detection of an attempt to compromise security in the residing node 410, the data is moved from the residing node 410 to the escrow node 420.

The escrow node 420 is a trusted intermediary. This trust may be achieved for example, through the use of the Trusted Computing Group's (TCG's) Trusted Network Connect (TNC). The TCG is a not-for-profit organization formed to develop, define and promote open standards for hardware-enabled trusted computing and security technologies, including hardware building blocks and software interfaces, across multiple platforms, peripherals and devices. TCG specifications aim to enable more secure computing environments without compromising functional integrity, privacy or individual rights. A primary goal is to help users protect their information assets, (e.g., data, passwords, keys, or the like), from compromise due to external software attack or physical theft. The TCG allows for a node to be evaluated for its level of security prior to it being allowed to participate in a network. One of the aims of this admission control is the protection of data residing on the network.

The TNC enables network operators to enforce policies regarding endpoint integrity at or after network connection. The TNC ensures multi-vendor interoperability across a wide variety of endpoints, network technologies and policies. In general, TCG establishes trust through a process of attestation where hash's of program and configuration data are compared to reference values. In accordance with the present invention, the difference in these values is used as an indication that a security breach is occurring, or has occurred. The detection of a malware, including a virus, may also be used as an indication of a security breach.

The data transferred to the escrow node 420 may be encrypted. The DRM approach of super-distribution may be used for this transfer. Alternatively, TCG's migratable keys facility may be used to transfer symmetric keys securely so that keys that can be used to decrypt the encrypted data, (i.e., primarily encrypted data on the residing node on which the decryption key has been deleted), may be securely transferred and stored on the escrow node, and the plaintext data may be accessed at the escrow node.

The data is stored in the escrow node 420 temporarily while the security situation at the residing node 410 is resolved. The behavior metrics which led to the decision to escrow the data may also be sent to the escrow node 420 or another intermediary node so that the proper resolution of the security problem may be addressed.

After a certain period of time subsequent to the data being moved to the escrow node 420, the escrow node 420 may delete the data if the user does not properly re-claim it. The administrator may offer to store the escrowed data for an extended period of time, or the user may request to hold the deletion.

The user of the data may specify the alternate residing node 430 to receive the data upon a security breach. If this is allowed by the usage rights and the security breach is not attributable to the user, the escrow node 420 may send the data to the alternate residing node 430.

The escrow node 420 may convert the security policy associated with the data to replace device specific designations, (e.g., a device ID), with values applicable to the alternate residing node 430. For example, if the data is tied to an ID of the residing node 410 under the associated security policy, the escrow node 420 converts any device IDs to be in agreement with the alternate residing node 430. The escrow node 420 may transfer the content and/or rights to the alternate residing node 430 using DRM transfer protocols rather than a bulk transfer so that each DRM transfer restriction is satisfied.

If it is determined by the escrow node 420 that the owner or user of the residing node 410 is not trustworthy, (e.g., the residing node 410 was physically attacked or the owner's fingerprints were found on the metal interconnect layer of some ICs as determined by a security bureau 460 after the owner followed the directions of the administrator of the escrow node and shipped or brought the residing node 410 to the security bureau 460 in hopes of gaining re-access to the data), then the data may be transferred from the escrow node 420 to the off-site node 440. The off-site node 440 is a separate node to which the owner or the user of the residing node 410 cannot physically access. The owner or user of the residing node 410 may still need access to some of the data, (e.g., if the data is needed for some vital function). In such case, access to the data may be allowed in a limited way. The limitation may be imposed by using DRM as to how the data may be edited, rendered and distributed.

After the data is moved to the escrow node 420, all of the stakeholders 450 of the data may be notified that the data is now residing in the escrow node 420 such that the stakeholders 450 may resolve the situation. The stakeholders 450 include, but are not limited to, the owner of the residing node 410, the user of the residing node 410 and the owner(s) of the data. These roles may be shared by the same entity.

Some data may have gone through various transformations involving the aggregation of data owned by various parties. This makes it difficult to send the data back to the owners of the data. A change history for the data may be maintained, and the paths that were followed to generate the data are retraced to send the data to the owners. The policies associated with the data may indicate that the data only needs to be partially retraced.

The security breach may place the residing node 410 in a persistent compromised state such as can exist with a virus infection that can not be removed. This compromised state may automatically be indicated on the residing node 410 by the setting of certain bits and the storage of descriptive information in a protected memory. Another node wanting to communicate with the residing node 410 may query this information to determine whether the residing node 410 is in a compromised state. The security bureau 460 may list an ID of the compromised nodes in a compromised device list. This ID may be the communications address of the node.

The security bureau 460 may take various forms. The security bureau 460 may be a single large organization with many offices opened for interacting with the public (similar to a postal service whether public, quasi-public, or private), or may be a federation of smaller companies where each member company is legally committed to follow common ethical standards and technical methodologies.

In order for the residing node 410 to have its compromise state cleared and to be taken off of the compromised device list, the owner or user of the residing node 410 may submit the residing node 410 to the security bureau 460. The security bureau 460 inspects the residing node 410 for impairments to its physical construction and cleans the residing node 410 of any configuration and software based impairments. If the residing node 410 passes the inspection, the security bureau 460 clears the compromise state of the residing node 410, for example, by using a special password reserved for the security bureau 460. The security bureau 460 may be entrusted with a password that allows write access to protected registers that indicate whether or not a node is in a compromised state. The use of the password may be automated and involve a challenge-response protocol with the node, making it more difficult for the personnel working at the security bureau 460 to gain access to the password.

The security bureau 460 also removes the residing node 410 from the compromised device list. The security bureau 460 may also issue a digitally signed certificate describing the initial problem, the solution, and the current state of the residing node 410. This certificate may be embedded in the residing node 410 and be available for review. The data that was uploaded to the escrow node 420 may be placed back on the residing node 410.

After a security mechanism for the data is implemented in accordance with the present invention, there may be remnants of the data in plaintext remaining on the node. This is most likely to occur if not all the data on the node has been protected. Therefore, as part of the data protection process, a search is conducted to see if the data is still residing somewhere on the node. The remnants may also be protected or may be deleted. This search may be performed by first evaluating data before it is encrypted and/or transferred off the node to determine if a section of the data has aspects of relative uniqueness upon which it is placed in a queue for searching the remainder of the node. A match results in the protection or deletion (wiping) of the data. This deletion can be dangerous as an independent piece of data can share informational aspects with the protected data being escrowed or entombed. Therefore, as part of the REL associated with the protected data, the node soon to become the residing node 410, agrees that by accepting the data, it accepts any unintended consequences of the automatic deletion of the data. An alternative or complementary approach is for a record to be kept of the copying of sections of protected data so that the selection of data for deletion can be performed deterministically. Any copy of protected data that is stored on a disk drive, even if only temporarily, in order to perform the procedures described here, will require that its location on the disk drive be wiped.

Although the features and elements of the present invention are described in the preferred embodiments in particular combinations, each feature or element can be used alone without the other features and elements of the preferred embodiments or in various combinations with or without other features and elements of the present invention. The methods in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any integrated circuit, and/or a state machine.

A processor in association with software may be used to implement a radio frequency transceiver for in use in a wireless transmit receive unit (WTRU), user equipment, terminal, base station, radio network controller, or any host computer. The WTRU may be used in conjunction with modules, implemented in hardware and/or software, such as a camera, a video camera module, a videophone, a speakerphone, a vibration device, a speaker, a microphone, a television transceiver, a handsfree headset, a keyboard, a Bluetooth module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for protecting data comprising:
detecting at least one of an attempt to compromise security of data stored in a residing node and an actual security breach of the data stored in the residing node; and
moving the data from the residing node to an escrow node upon detection of at least one of the attempt to compromise security and the actual security breach, the escrow node being a trustworthy intermediary node.

2. The method of claim 1 wherein trust of the escrow node is achieved through the use of a Trusted Computing Group's Trusted Network Connect (TNC).

3. The method of claim 2 wherein the actual security breach of the stored data is detected by comparing hash's of a program and configuration data to reference values.

4. The method of claim 2 wherein the actual security breach of the stored data is determined by detection of malware.

5. The method of claim 1 wherein the data is encrypted for transmission to the escrow node.

6. The method of claim 1 wherein the data is transmitted to the escrow node using digital rights management (DRM) super-distribution.

7. The method of claim 2 wherein the data is transmitted to the escrow node using the Trusted Computing Group's migratable keys facility to transfer symmetric keys securely.

8. The method of claim 1 wherein the attempt to compromise security of the data and the actual security breach of the data are detected by evaluating behavior metrics of the residing node through an evaluation procedure.

9. The method of claim 8 wherein the behavior metrics indicate at least one of the following: that malware has been detected in the residing node, that anti-virus software in the residing node is out-of-date, that digital signatures of software, firmware and configuration data in the residing node cannot be verified, that hash codes of software, firmware and configuration data in the residing node cannot be verified, that an attempt to penetrate physical security of the residing node has been detected, that the residing node has accessed other nodes having a certain probability of being comprised, that the residing node was accessed by other nodes having a certain probability of being compromised, and that the residing node is taken out of or placed into a certain physical locations.

10. The method of claim 8 wherein the evaluation procedure includes a set of ordered rules, wherein, for each rule, if a certain condition is present, a set of actions are taken.

11. The method of claim 8 wherein the evaluation procedure takes a form of a weighted sum with a threshold, wherein each threshold is associated with a different security level.

12. The method of claim 8 wherein the evaluation procedure takes a form of elaborate if-then statements.

13. The method of claim 8 wherein the behavior metrics are also sent to the escrow node.

14. The method of claim 1 further comprising:
sending a message to all of stakeholders of the data, the message indicating that the data is now residing in the escrow node, whereby the stakeholders take an action to resolve the security breach.

15. The method of claim 14 wherein the stakeholders include an owner of the residing node, a user of the residing node and an owner of the data.

16. The method of claim 1 wherein a security bureau adds the residing node to a compromised device list.

17. The method of claim 16 further comprising:
an owner of the residing node submitting the residing node to the security bureau;
the security bureau inspecting the residing node; and
the security bureau clearing the compromise state of the residing node if the inspection passes.

18. The method of claim 17 further comprising:
the security bureau determining if physical tampering occurred at the residing node;
if physical tampering occurred, the security bureau notifying the escrow node about the physical tampering; and
the escrow node moving the data to an off-site node.

19. The method of claim 17 wherein the security bureau uses a password reserved for security bureaus to clear the compromise state.

20. The method of claim 17 further comprising:
the security bureau removing the residing node from the compromised device list if the residing node passes the inspection.

21. The method of claim 17 further comprising:
the security bureau issuing a certificate describing an initial problem, a solution, and a current state of the residing node if the residing node passes the inspection.

22. The method of claim 21 wherein the certificate is embedded in the residing node.

23. The method of claim 1 wherein a compromised state of the residing node is automatically indicated upon detection of one of the attempt to compromise security and the actual security breach.

24. The method of claim 23 wherein the compromised state is indicated by setting a certain bit in a protected memory.

25. The method of claim 1 further comprising:
the escrow node moving the data to an alternate node designated by an owner of the residing node.

26. The method of claim 25 wherein the escrow node converts a security policy to replace device specific designations with values applicable to the alternate node.

27. The method of claim 25 wherein the escrow node transfers the data to the alternate node using digital rights management (DRM) protocol.

28. The method of claim 1 further comprising:
the escrow node deleting the data after a certain period of time if an owner of the data does not reclaim it.

29. The method of claim 1 further comprising:
the escrow node transferring the data to an off-site node if it is determined by the escrow node that an owner or user of the residing node is not trustworthy.

30. The method of claim 29 wherein the off-site node is a separate node to which the owner or the user of the residing node cannot physically access.

31. The method of claim 29 wherein the owner or user of the residing node is given a limited access to the data.

32. The method of claim 31 wherein the limited access is given by using digital rights management (DRM).

33. The method of claim 1 further comprising:
conducting a search to determine whether the data remains elsewhere on the residing node, whereby the data is either protected or deleted.

34. A method of protecting data comprising:
detecting an attempt to compromise security of data stored in a residing node; and
disallowing a usage right associated with the data.

35. A method of protecting data stored in a residing node, the method comprising:
detecting an attempt to compromise security of data stored in a residing node; and
sending a message to a generator of the data to inform the generator of the detected attempt to compromise security of the stored data, whereby the generator takes an action to protect the stored data.

36. The method of claim 35 wherein the message includes a warning of the detected attempt to compromise security of the stored data.

37. The method of claim 35 wherein the message further includes specific information about the detected attempt to compromise security of the stored data.

38. The method of claim 35 wherein the data is identified with a universal unique identifier (UUID) assigned to the data when the data is generated.

39. A method of protecting data comprising:
detecting an attempt to compromise security of data stored in a residing node; and
the residing node sending a message to an intermediary node as a notification regarding the detected attempt to compromise security of the stored data;
the intermediary node issuing a new encryption key to the residing node; and
the residing node encrypting the data with the new encryption key.

40. The method of claim 39 wherein the intermediary node supplies an encryption key in advance of detection of the attempt to compromise security of the stored data so that encryption is performed on a continuous basis.

41. The method of claim 39 wherein the encryption key is a symmetric key.

42. The method of claim 41 wherein the intermediary node periodically issues a symmetric key to be used for background encryption of data.

43. The method of claim 42 wherein each time a new symmetric key is issued by the intermediary node, the residing node encrypts an old symmetric key with a new symmetric key and deletes the old symmetric key.

44. The method of claim 42 wherein the symmetric key is encrypted by an intermediary node's encryption key.

45. The method of claim 44 wherein the intermediary node's encryption key is only known by the intermediary node.

46. The method of claim 42 wherein each symmetric key sent by the intermediary node is accompanied by a code, and the residing node associates this code with data that the respective symmetric key encrypts.

47. A system for protecting data comprising:
a residing node comprising:
a user data module for storing data; and
a security module for detecting at least one of an attempt to compromise security of the stored data and an actual security breach of the stored data in the residing node; and
an escrow node for moving the data from the residing node upon detection of at least one of the attempt to compromise security of the stored data and the actual security breach of the stored data, the escrow node being a trustworthy intermediary node.

48. The system of claim 47 wherein trust of the escrow node is achieved through the use of a Trusted Computing Group's Trusted Network Connect (TNC).

49. The system of claim 48 wherein the actual security breach of the data is detected by comparing hash's of a program and configuration data to reference values.

50. The system of claim 48 wherein the actual security breach of the data is determined by detection of malware.

51. The system of claim 47 wherein the residing node encrypts the data for transmission to the escrow node.

52. The system of claim 47 wherein the data is transmitted to the escrow node using digital rights management (DRM) super-distribution.

53. The system of claim 48 wherein the data is transmitted to the escrow node using the Trusted Computing Group's migratable keys facility to transfer symmetric keys securely.

54. The system of claim 47 wherein the attempt to compromise security of the data and the actual security breach of the data are detected by evaluating behavior metrics of the residing node through an evaluation procedure.

55. The system of claim 53 wherein the behavior metrics indicate at least one of the following: that malware has been detected in the residing node, that anti-virus software in the residing node is out-of-date, that digital signatures of software, firmware and configuration data in the residing node cannot be verified, that hash codes of software, firmware and configuration data in the residing node cannot be verified, that an attempt to penetrate physical security of the residing node has been detected, that the residing node has accessed other nodes having a certain probability of being comprised, that the residing node was accessed by other nodes having a certain probability of being compromised, and that the residing node is taken out of or placed into a certain physical location.

56. The system of claim 54 wherein the evaluation procedure includes a set of ordered rules, wherein, for each rule, if a certain condition is present, a set of actions are taken.

57. The system of claim 54 wherein the evaluation procedure takes a form of a weighted sum with a threshold, wherein each threshold is associated with a different security level.

58. The system of claim 54 wherein the evaluation procedure takes a form of elaborate if-then statements.

59. The system of claim 54 wherein the behavior metrics are sent to the escrow node.

60. The system of claim 47 wherein the residing node sends a message to all of stakeholders of the data, the message indicating that the data is now residing in the escrow node, whereby the stakeholders take an action to resolve the security breach.

61. The system of claim 60 wherein the stakeholders include an owner of the residing node, a user of the residing node and an owner of the data.

62. The system of claim 47 further comprising a security bureau configured to add the residing node to a compromised device list.

63. The system of claim 62 wherein an owner of the residing node submits the residing node to the security bureau, and the security bureau inspects the residing node and clears the compromise state of the residing node if the inspection passes.

64. The system of claim 63 wherein the security bureau determines if physical tampering occurred at the residing node and, if physical tampering occurred, notifies the escrow node about the physical tampering and the escrow node moves the data to an off-site node.

65. The system of claim 63 wherein the security bureau uses a password reserved for security bureaus to clear the compromise state.

66. The system of claim 63 wherein the security bureau removes the residing node from the compromised device list if the residing node passes the inspection.

67. The system of claim 63 wherein the security bureau issues a certificate describing an initial problem, a solution, and a current state of the residing node if the residing node passes the inspection.

68. The system of claim 67 wherein the certificate is embedded in the residing node.

69. The system of claim 47 wherein a compromised state of the residing node is automatically indicated upon detection of one of the attempt and the security breach.

70. The system of claim 69 wherein the compromised state is indicated by setting a certain bit in a protected memory.

71. The system of claim 47 wherein the escrow node moves the data to an alternate node designated by an owner of the residing node.

72. The system of claim 71 wherein the escrow node converts a security policy to replace device specific designations with values applicable to the alternate node.

73. The system of claim 71 wherein the escrow node transfers the data to the alternate node using digital rights management (DRM) protocol.

74. The system of claim 47 wherein the escrow node deletes the data after a certain period of time if an owner of the data does not reclaim it.

75. The system of claim 47 wherein the escrow node transfers the data to an off-site node if it is determined by the escrow node that an owner or user of the residing node is not trustworthy.

76. The system of claim 75 wherein the off-site node is a separate node to which the owner or the user of the residing node cannot physically access.

77. The system of claim 75 wherein the owner or user of the residing node is given a limited access to the data.

78. The system of claim 77 wherein the limited access is given by using digital rights management (DRM).

79. The system of claim 47 wherein the residing node and the escrow node conduct a search to determine whether the data remains elsewhere in the system, whereby the data is either protected or deleted.

80. A node for protecting data comprising:
a user data module for storing data; and
a security module for detecting an attempt to compromise security of the stored data in the node and for disallowing a usage right associated with the stored data.

81. A system for protecting data comprising:
a generator of data; and
a residing node comprising:
a user data module for storing data; and
a security module for detecting an attempt to compromise security of the stored data and for sending a message to the generator of the data to inform the generator of the attempt to compromise security of the stored data, whereby the generator takes an action to protect the stored data.

82. The system of claim 81 wherein the message includes a warning of the detected attempt to compromise security of the stored data.

83. The system of claim 81 wherein the message further includes specific information about the detected attempt to compromise security of the stored data.

84. The system of claim 81 wherein the data is identified with a universal unique identifier (UUID) assigned to the data when the data is generated.

85. A system for protecting data comprising:
an intermediary node; and
a residing node comprising:
a user data module for storing data; and
a security module for detecting an attempt to compromise security of the stored data,
wherein the residing node sends a message to the intermediary node as a notification regarding the attempt to compromise security of the stored data, the intermediary node issues a new encryption key to the residing node and the residing node encrypts the stored data with the new encryption key.

86. The system of claim 85 wherein the intermediary node supplies an encryption key in advance of detection of the attempt to compromise security of the stored data so that encryption is performed on a continuous basis.

87. The system of claim 86 wherein the encryption key is a symmetric key.

88. The system of claim 85 wherein the intermediary node periodically issues a symmetric key to be used for background encryption of data.

89. The system of claim 88 wherein each time a new symmetric key is issued by the intermediary node, the residing node encrypts an old symmetric key with a new symmetric key and deletes the old symmetric key.

90. The system of claim 88 wherein the symmetric key is encrypted by an intermediary node's encryption key.

91. The system of claim 90 wherein the intermediary node's encryption key is only known by the intermediary node.

92. The system of claim 88 wherein each symmetric key sent by the intermediary node is accompanied by a code, and the residing node associates this code with data that the respective symmetric key encrypts.
